(19) United States
(12) Patent Application Publication
(10) Pub. No.: US 2023/0284075 A1
(43) Pub. Date: Sep. 7, 2023

(54) Intelligent Near-RT-RIC Based RF Management

(71) Applicant: Parallel Wireless, Inc., Nashua, NH (US)

(72) Inventors: Sunil Jamkhandikar, Pune (IN); Ravikiran Raje, Pune (IN)

(21) Appl. No.: 18/171,808

(22) Filed: Feb. 21, 2023

Related U.S. Application Data
(60) Provisional application No. 63/311,511, filed on Feb. 18, 2022.

(51) Int. Cl. H04W 28/02; H04W 16/14; H04W 24/10

(52) U.S. Cl. CPC H04W 28/0236; H04W 16/14; H04W 24/10; H04W 24/02

(57) ABSTRACT

A system is described which can identify inconsistent coverage (grey spots) or coverage black spots based on real time network and user reported event patterns, and dynamically improve the RF coverage in the identified areas based on UE location reporting.

A method is disclosed for providing near-RT-RIC based RF management for a network. In one embodiment, the method includes subscribing, by a near-RT RIC to the CU, real time UE reported event patterns; identifying from the reported event patterns one or more of inconsistent coverage and area where no coverage is received; reporting to the near-RT RIC when serving becomes better than a threshold or serving becomes worse than the threshold pattern fluctuations or cell-edge condition patterns with serving becomes better than a threshold or serving becomes worse than the threshold pattern fluctuations and wherein a neighbor becomes offset better than serving and neighbor becomes better than threshold; and taking dynamic corrective actions to self-heal the networks inconsistent coverage.

### CROSS-REFERENCE TO RELATED APPLICATIONS

This application claims priority under 35 U.S.C. § 119(e) to U.S. Provisional Pat. Application No. 63/311,511, filed Feb. 18, 2022 and having the same title as the present application, which is hereby incorporated by reference in its entirety for all purposes. This application also hereby incorporates by reference, for all purposes, each of the following U.S. Pat. Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. Pat. App. No. 14/034,915, “Dynamic Multi-Access Wireless Network Virtualization,” filed Sep. 24, 2013; U.S. Pat. App. No. 14/289,821, “Method of Connecting Security Gateway to Mesh Network,” filed May 29, 2014; U.S. Pat. App. No. 14/500,989, “Adjusting Transmit Power Across a Network,” filed Sep. 29, 2014; U.S. Pat. App. No. 14/506,587, “Multicast and Broadcast Services Over a Mesh Network,” filed Oct. 3, 2014; U.S. Pat. App. No. 14/510,074, “Parameter Optimization and Event Prediction Based on Cell Heuristics,” filed Oct. 8, 2014, U.S. Pat. App. No. 14/642,544, “Federated X2 Gateway,” filed Mar. 9, 2015, and U.S. Pat. App. No. 14/936,267, “Self-Calibrating and Self-Adjusting Network,” filed Nov. 9, 2015; U.S. Pat. App. No. 15/607,425, “End-to-End Prioritization for Mobile Base Station,” filed May 26, 2017; U.S. Pat. App. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9107092, 8867418, and 9232547 in their entirety. This document also hereby incorporates by reference U.S. Pat. App. No. 14/822,839, U.S. Pat. App. No. 15/828427, U.S. Pat. App. Pub. Nos. US20170273134A1, US20170127409A1 in their entirety. In addition, 3GPP TS 36.413 and TS 36.331 are also incorporated by reference in their entirety for all purposes.

### BACKGROUND

In commissioned networks where RF planning is already done, there can arise areas or spots where the network coverage fluctuates between good and bad based on a variety of factors. The serving cell’s coverage in particular spots in the cell area may face problems due to following probable reasons: Enb not transmitting at expected power; Natural conditions changing for reasons such as, for example, a tree branch blocking the directional beam of a cell antenna and needs coverage optimization, which can be handled dynamically using directional antenna changes or manual network planning; and Enb transmitting at correct power, but without users being able to latch on, which needs to be attended to.

### SUMMARY

A system is described which can identify inconsistent coverage (grey spots) or coverage black spots based on real time network and user reported event patterns, and dynamically improve the RF coverage in the identified areas based on UE location reporting.

A method is disclosed for providing near-RT-RIC based RF management for a network. In one embodiment, the method includes subscribing, by a near-RT RIC to the CU, real time UE reported event patterns; identifying from the reported event patterns one or more of inconsistent coverage and area where no coverage is received; reporting to the near-RT RIC when serving becomes better than a threshold or serving becomes worse than the threshold pattern fluctuations or cell-edge condition patterns with serving becomes better than a threshold or serving becomes worse than the threshold pattern fluctuations and wherein a neighbor becomes offset better than serving and neighbor becomes better than threshold; and taking dynamic corrective actions to self-heal the networks inconsistent coverage.

### BRIEF DESCRIPTION OF THE DRAWINGS

FIG. 1 shows threshold levels detected from UE measurements and configured network thresholds, in accordance with some embodiments.

FIG. 2 shows a planned RF network, in accordance with some embodiments.

FIG. 3 shows an O-RAN architecture and components involved, in accordance with some embodiments.

FIG. 4 shows an example, in accordance with some embodiments, of a UE on cell edge not getting neighbor eNodeB3 coverage and no neighbor events detected on location which should be cell edge.

FIG. 5 is a schematic network architecture diagram for 3G and other-G networks, in accordance with some embodiments.

FIG. 6 is an enhanced eNodeB for performing the methods described herein, in accordance with some embodiments.

FIG. 7 is a coordinating server for providing services and performing methods as described herein, in accordance with some embodiments.

### DETAILED DESCRIPTION

In a wireless network, there can arise areas or spots where the network coverage fluctuates between good and bad based on a variety of factors. Such problem areas where for example the served cell’s signal fluctuates between A1, A2 events based on operator configured thresholds, and keeps fluctuating can be considered as network “Grey Spots”. “Black Spots” are considered as areas where no coverage is received.

“Grey Spot” areas where A1, A2 is fluctuating and near cell edge but A3, A4 events are not received which can be an anomaly not intended as per the original RF planning and needs to be fixed. These include: A1 event - Serving becomes better than threshold; A2 event - Serving becomes worse than threshold; A3 event - Neighbor becomes offset better than serving; A4 event - Neighbor becomes better than threshold; and A5 event - Serving becomes worse than threshold1 and neighbor becomes better than threshold2.

The solution proposed helps identify exact location of coverage spots where aforementioned Grey and Black spots occur, using real time UE reported event patterns. This can be subscribed for by the Near-RT RIC to the CU, which can report back to the Near-RT RIC when the unexpected A1,A2 event pattern fluctuations or cell-edge condition patterns with A1,A2 fluctuating and no A3,A4 detected.

The grey spot identification can be done based on pre-set trigger where the same fluctuating event pattern occurs a few number of times. Using the solution defined in “Location Detection for Public Safety deployments” the exact location of the UE where the inconsistent rf coverage patterns are observed can be found out. This real time reporting and identification of grey spots and black spots in the coverage can help improve the network user experience and identify spots which are not possible to detect even with operator’s RF drive test in some cases.

Based on Black/Grey spot identification, the following dynamic corrective actions are proposed to be done to self-heal the network’s inconsistent coverage, to be performed in various combinations in accordance with some embodiments: software defined radio adjustments using directional antenna changes; dynamic decisions of RF power adjustment, wherein one or more cells are adjusted up or down, can be taken based on the criteria’s related to number of users hitting same event patterns in identified coverage Grey spots; and in event patterns detected in specific spots near cell edge, if A1 A2 is being hit repetitively without hitting A3, A4 which indicates that there is a neighbor becoming better than serving/configured threshold as per the intended RF network planning which was done during deployment time, then there is a situation which is not as per planned, and now this identifies an issue which needs to be attended. Now once such situations are detected or grey spot identified, we can dynamically adjust network conditions based on software defined radio management. If A3, A4 events were not hit even though they were expected based on RF planning when network was commissioned, we need to dynamically check if the radio power management for neighbor cell is as per expected, and if not adjust using software defined radio management.

The Near-RT-RIC can also prepare network intelligence gathered report from real-time events and this automated network analytics report can be shared with the operator, for any manual intervention in Rf management if needed.

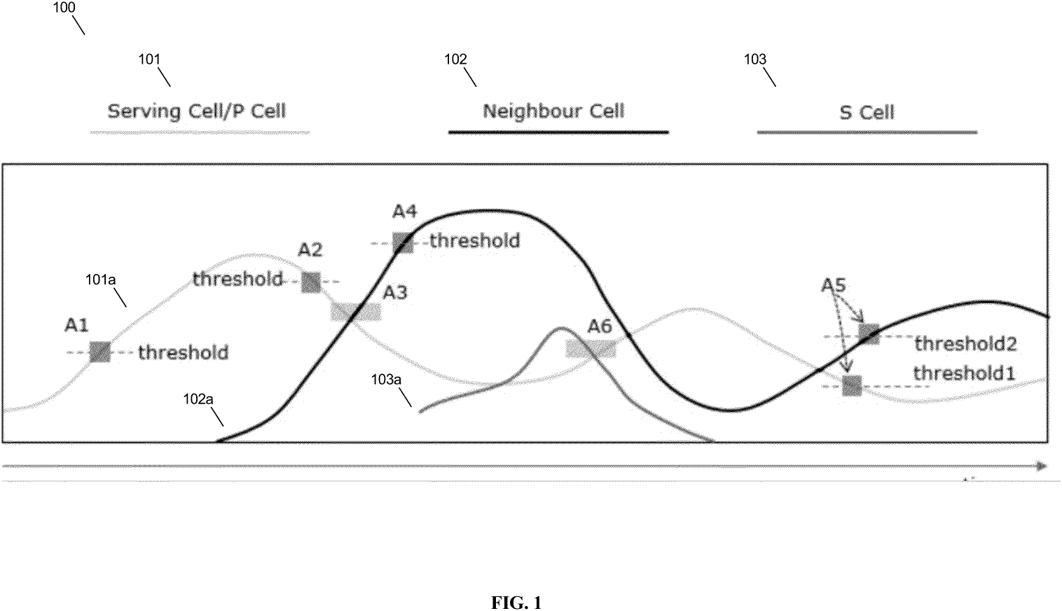

FIG. 1 shows 100 threshold levels detected from UE measurements and configured network thresholds, in accordance with some embodiments. Serving cell/P cell 101 is shown with curve 101a. Neighbor cell 102 is shown with curve 102a. S cell 103 is shown with curve 103a. Thresholds A1, A2, A3, A4, A5, A6 are shown.

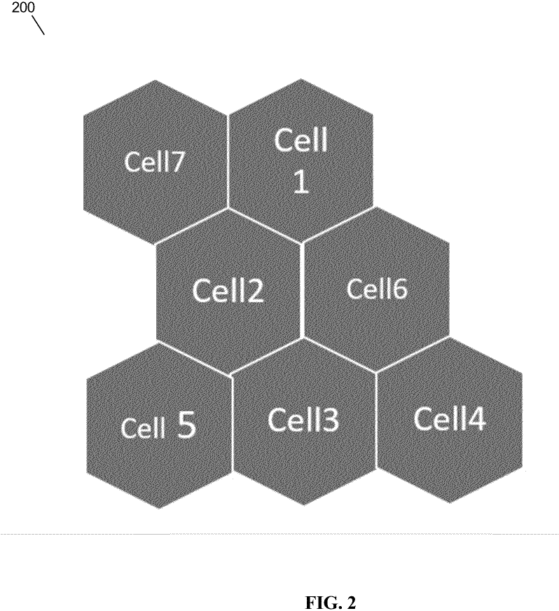

FIG. 2 shows a planned RF network, in accordance with some embodiments.

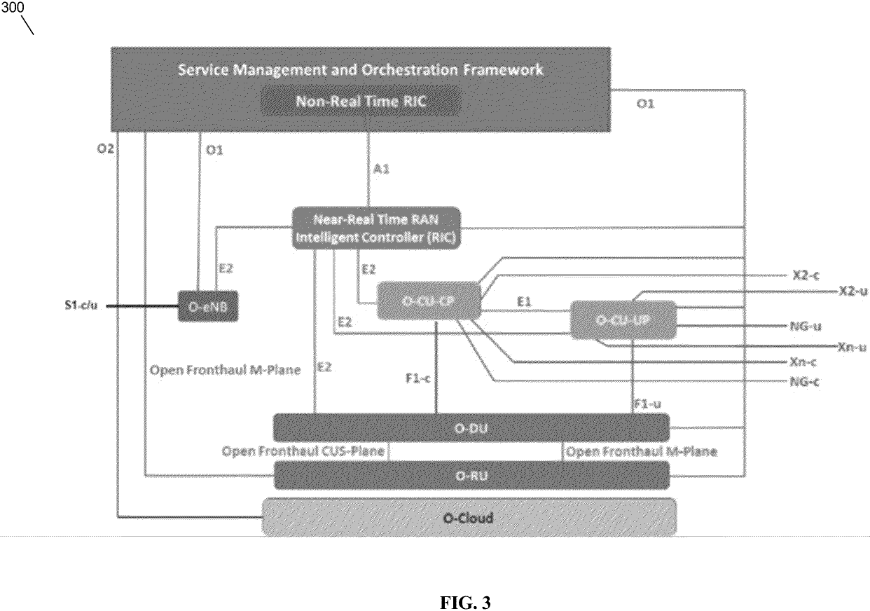

FIG. 3 shows an O-RAN architecture and components involved, in accordance with some embodiments. UE location can be determined and this can be implemented on the CU which will be the VRU in Parallel Wireless solution in open RAN model, in accordance with the O-RAN architecture.

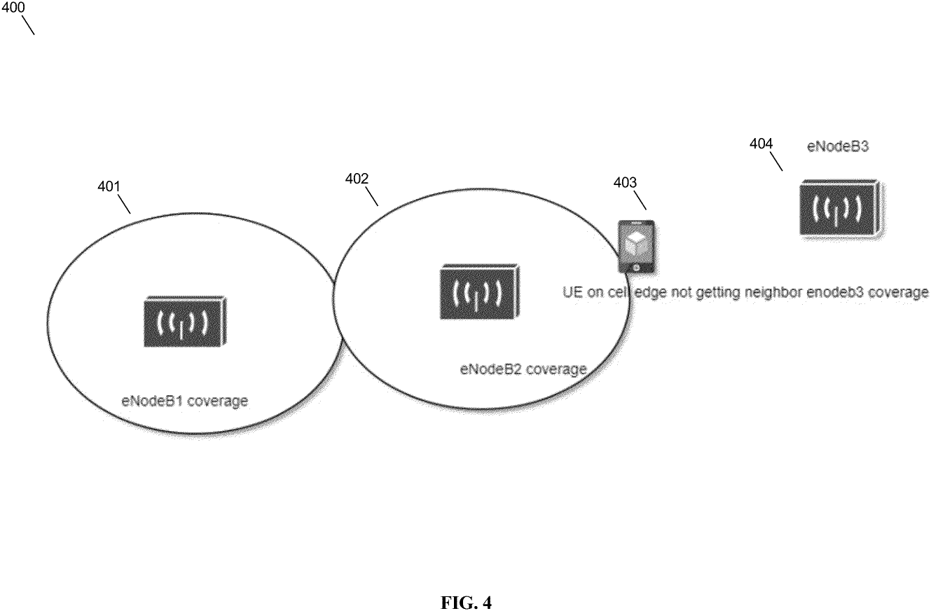

FIG. 4 shows an example, in accordance with some embodiments, of a UE on cell edge not getting neighbor eNodeB3 coverage and no neighbor events detected on location which should be cell edge.

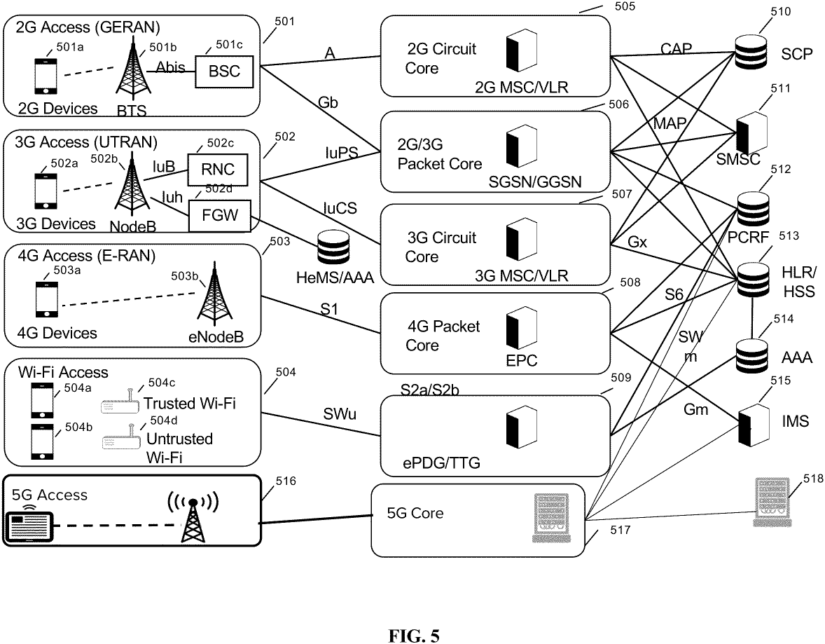

FIG. 5 is a schematic network architecture diagram for 3G and other-G networks, in accordance with some embodiments. The diagram shows a plurality of “Gs,” including 2G, 3G, 4G, 5G and Wi-Fi. 2G is represented by GERAN 501, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

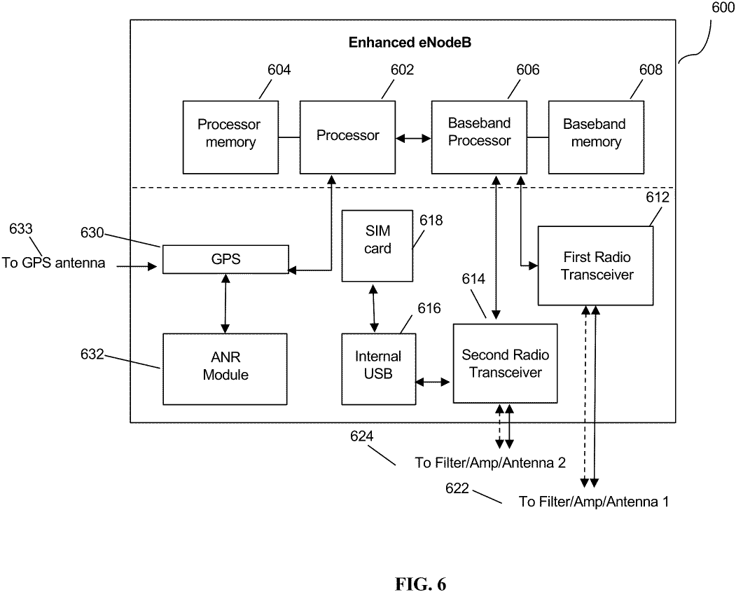

FIG. 6 is an enhanced eNodeB for performing the methods described herein, in accordance with some embodiments. Mesh network node 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

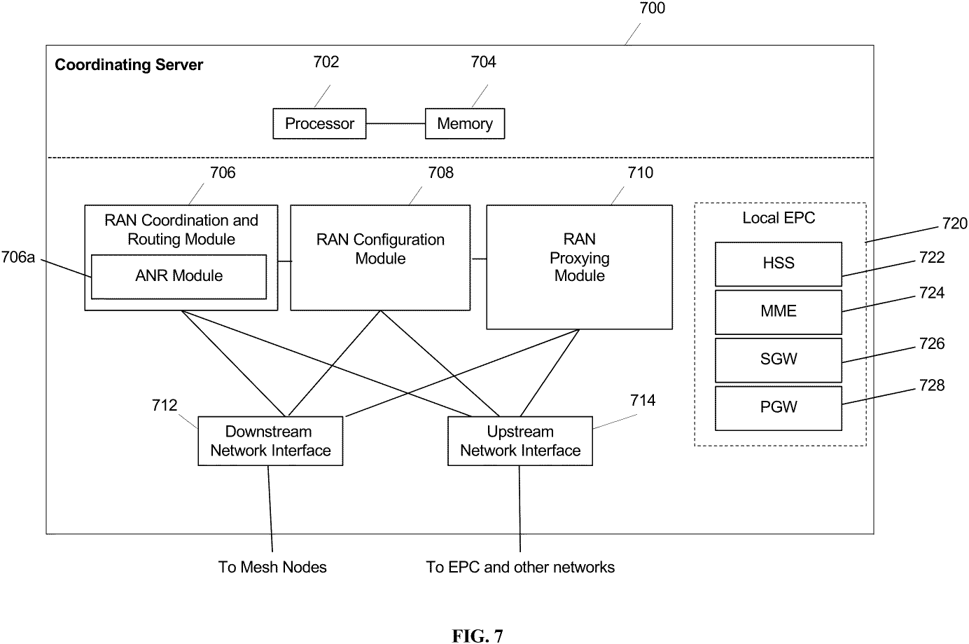

FIG. 7 is a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

In some embodiments, coordinating server 700 includes local evolved packet core (EPC) module 720, for authenticating users, storing and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device. In some embodiments, coordinating server 700 may also include a near-RT RIC, performing the functions described herein. In some embodiments, coordinating server 700 may also include a non-RT RIC, performing the functions described herein.

In 5GC, the function of the SGW is performed by the SMF and the function of the PGW is performed by the UPF. The inventors have contemplated the use of the disclosed invention in 5GC as well as 5G/NSA and 4G. As applied to 5G/NSA, certain embodiments of the present disclosure operate substantially the same as the embodiments described herein for 4G. As applied to 5GC, certain embodiments of the present disclosure operate substantially the same as the embodiments described herein for 4G, except by providing an N4 communication protocol between the SMF and UPF to provide the functions disclosed herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method of providing near real time radio access network (RAN) intelligent controller (near-RT RIC)-based radio frequency (RF) management for a network, the method comprising:
subscribing, by a near-RT RIC to the centralized unit (CU), real time user equipment (UE)-reported event patterns;
determining, from the reported event patterns, one or more of a coverage inconsistency and a poor coverage area;
reporting, to the near-RT RIC, a change in the real time UE-reported event patterns against a threshold; and
taking dynamic corrective action to self-heal the coverage inconsistency or poor coverage area.

2. The method of claim 1, wherein determining from the reported event patterns occurs at the near-RT RIC.

3. The method of claim 1, wherein serving becomes better than a threshold.

4. The method of claim 1, wherein serving becomes worse than a threshold.

5. The method of claim 1, wherein at least one threshold is fluctuating.

6. The method of claim 1, wherein serving becomes worse than a threshold.

7. The method of claim 1, further comprising receiving A1, A2 event pattern fluctuations at the near-RT RIC.

8. The method of claim 1, further comprising receiving A1, A2 event pattern fluctuations and no A3, A4 detected at the near-RT RIC.
